(19) United States
(12) Patent Application Publication
(10) Pub. No.: US 2012/0324214 A1
(43) Pub. Date: Dec. 20, 2012

(54) Method and Apparatus to Provide Attestation with PCR Reuse and Existing Infrastructure

(75) Inventors: Nadarajah Asokan, Espoo (FI); Jan-Erik Ekberg, Vanda (FI); Kari Timo Juhani Kostiainen, Helsinki (FI)

(73) Assignee: NOKIA CORPORATION, Espoo (FI)

(21) Appl. No.: 13/579,013

(22) PCT Filed: Feb. 16, 2011
(86) PCT No.: PCT/IB2011/050652

§ 371 Date: Aug. 14, 2012

Related U.S. Application Data
(60) Provisional application No. 61/305,011, filed on Feb. 16, 2010.

(51) Int. Cl. G06F 21/00

(52) U.S. Cl. 713/100

(57) ABSTRACT

The exemplary embodiments or the invention provide at least a method, apparatus, and program of computer instructions to perform operations including receiving a challenge from a prover device, reading and saving an old value of a selected platform configuration register, obtaining at least one measurement or property and forming a new platform configuration register value, where the forming includes calculating a cryptographic hash over the old value of the platform configuration register and the obtained at least one measurement or property, triggering, with the trusted software, an attestation by sending a challenge to a trusted platform module/mobile platform module, and sending by the prover device a device certificate, attestation, at least one measurement or property, and old platform configuration register value to the verifier. Further, the exemplary embodiments or the invention teach sending a challenge to a trusted software of a prover device, and receiving by the verifier device a device certificate, attestation, at least one measurement or property, and an old platform configuration register value from the prover device, checking by the verifier device that extending the old platform configuration register value with the at least one measurement or property results in a new platform configuration register value that has been attested, and using the new platform configuration register value in attestation of the prover device.

### TECHNICAL FIELD

The exemplary and non-limiting embodiments of this invention relate generally to trusted computing, security and the use of a mobile trusted module in, for example, a wireless communication system.

### BACKGROUND

This section is intended to provide a background or context to the invention. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

AIK attestation identity key
ASIC application specific integrated circuit
HW hardware
MTM mobile trusted module
OS operating system
PCR platform configuration register
RIM reference integrity metric
SW software
TCB trusted computing base
TCG trusted computing group
TPM trusted platform module

Traditionally “(entity) authentication” refers to demonstrating the claimed identity of a prover entity (i.e., a person or device) towards a (usually remote) verifier, such as an internal or external verifier device. In many usage scenarios there is a parallel need for the verifier to check and validate the identity or attributes of the software (and hardware) being used by the prover entity.

In the architecture developed by the Trusted Computing Group (TCG) for Trusted Platform Modules (TPM) and Mobile Trusted Modules (MTM), this process is referred to as “attestation” (see “TSG Specification Architecture Overview”, Specification Revision 1.4, 2 Aug. 2007). TCG attestation includes “measuring” a local configuration and reporting the measurement to the verifier by signing it using a device-specific, certified key. In this procedure “measuring” typically refers to a representation of program executables, such as a cryptographic hash of program executable code.

Reference with regard to MTM can be made to “Mobile Trusted Module (MTM)—an introduction”, Jan-Erik Ekberg, Markku Kylámpáá, Nokia Research Center, NRC-TR-2007-105, Nov. 14, 2007.

Deploying an attestation scheme based on exact measurements of executable program code is difficult because of the large number and large size of software components on modern computing devices, and the need to frequently update and install new software to the device.

It has been proposed to use “property-based attestation” as an alternative. In property-based attestation a trusted authority defines a mapping from exact software measurements to properties which can then be attested to an external verifier. Although there have been several academic publications on property-based and behavior-based (also known as “semantic”) attestation, there has been no concrete instantiations of relevant properties nor large scale deployments.

A reference for describing a conventional property-based attestation approach can be made to, for example, Ahm ad-Reza Sadeghi and Christian Stable, “Property-based Attestation for Computing Platforms: Caring about properties, not mechanisms”, Proceedings of the 2004 Workshop on New Security Paradigms.

### SUMMARY

In an exemplary aspect of the invention, there is a method, comprising: receiving a challenge from a verifier device at a trusted software of a prover device, in response to the received challenge, the trusted software reading and saving an old value of a selected platform configuration register, obtaining at least one measurement or property and forming a new platform configuration register value, where the forming comprises calculating a cryptographic hash over the old value of the platform configuration register and the obtained at least one measurement or property, triggering, with the trusted software, an attestation by sending a challenge to a trusted platform module/mobile platform module, where the attestation is a signature over the new platform configuration register value and the challenge, and sending by the prover device a device certificate, attestation, at least one measurement or property, and old platform configuration register value to the verifier device.

In an exemplary aspect of the invention, there is an apparatus, comprising: at least one data processor, and at least one memory including at least one program of computer instructions, where the at least one memory and the at least one program of computer instructions are configured, with the at least one data processor, to cause the apparatus to at least: receive a challenge from a verifier device at a trusted software, in response to the received challenge, read and save an old value of a selected platform configuration register, obtain at least one measurement or property and forming a new platform configuration register value, where the forming comprises calculating a cryptographic hash over the old value of the platform configuration register and the obtained at least one measurement or property, trigger, with the trusted software, an attestation by sending a challenge to a trusted platform module/mobile platform module, where the attestation is a signature over the new platform configuration register value and the challenge, and send a device certificate, attestation, at least one measurement or property, and old platform configuration register value to the verifier device.

In an exemplary aspect of the invention, there is an apparatus, comprising: means for receiving a challenge from a verifier device at a trusted software, means, in response to the received challenge, for reading and saving an old value of a selected platform configuration register, means for obtaining at least one measurement or property and forming a new platform configuration register value, where the forming comprises calculating a cryptographic hash over the old value of the platform configuration register and the obtained at least one measurement or property, means for triggering, with the trusted software, an attestation by sending a challenge to a trusted platform module/mobile platform module, where the attestation is a signature over the new platform configuration register value and the challenge, and means for sending a device certificate, attestation, at least one measurement or property, and old platform configuration register value to the verifier device.

In another exemplary aspect of the invention, there is an method, comprising: sending, from a verifier device, a challenge toward a trusted software of a prover device, and based on the sending, receiving by the verifier device a device certificate, attestation, at least one measurement or property, and an old platform configuration register value from the prover device, checking by the verifier device that extending the old platform configuration register value with the at least one measurement or property results in a new platform configuration register value that has been attested, and using the new platform configuration register value in attestation of the prover device.

In still another exemplary aspect of the invention, there is an apparatus, comprising: at least one data processor, and at least one memory including at least one program of computer instructions, where the at least one memory and the at least one program of computer instructions are configured, with the at least one data processor, to cause the apparatus to at least: send, from a verifier device, a challenge toward a trusted software of a prover device, and based on the sending, receive by the verifier device a device certificate, attestation, at least one measurement or property, and an old platform configuration register value from the prover device, check by the verifier device that extending the selected platform configuration register value with the at least one measurement or property results in a new platform configuration register value that has been attested, and use the new platform configuration register value in attestation of the prover device.

In yet another exemplary aspect of the invention, there is an apparatus, comprising: means for sending, from a verifier device, a challenge toward a trusted software of a prover device, and means, based on the sending, for receiving by the verifier device a device certificate, attestation, at least one measurement or property, and an old platform configuration register value from the prover device, means for checking by the verifier device that extending the old platform configuration register value with the measurement results in a new platform configuration register value that has been attested, and means for using the new platform configuration register value in attestation of the prover device.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 presents a message flow diagram that illustrates attestation with PCR re-use in accordance with an exemplary embodiment of this invention.

FIG. 2 presents a message flow diagram that illustrates the attestation with PCR re-use as in FIG. 1 used with existing infrastructure, in accordance with an exemplary further embodiment of this invention.

FIG. 3 is a simplified block diagram showing a mobile platform and an access point, where the mobile platform includes a TPM/MTM and trusted software that is operated in accordance with the exemplary embodiments of this invention to provide PCR re-use.

FIGS. 4, 5, and 6 are logic flow diagrams that each illustrate the operation of a method, and a result of execution of computer program instructions, in accordance with the exemplary embodiments of this invention.

### DETAILED DESCRIPTION

The existing TCG style property-based attestation schemes exhibit at least the following two problems.

First, a typical property-based attestation system may have an arbitrary number of properties to attest, but only a limited number of platform configuration registers (PCR) available. In TCG style attestation software components are measured by the operating system as they are loaded and properties that match the measurements are accumulated into available PCRs. Since there typically are more properties to attest than PCRs available, multiple properties typically need to be accumulated into a single PCR. When a remote verifier requests the attestation of one property, the prover is forced to attest all the properties accumulated into that PCR. This approach can thus disclose or “leak” unnecessary information about the prover, and could result in a privacy violation.

Second, existing property-based attestation schemes are dependent on certification infrastructure. To deploy a property-based attestation scheme a trusted authority should inspect (possibly a very large number of) software components and certify mappings from exact software configurations to certain properties. Setting up and running such a certification infrastructure is a considerable task, and dependency on this kind of infrastructure is a formidable barrier against real-world deployments of property-based attestation.

The exemplary embodiments of this invention provide improvements to existing property-based attestation schemes, and address and solve at least the two problems outlined above.

In a first aspect the exemplary embodiments provide a technique for “re-using” a PCR. This re-use technique enables attesting an arbitrary number of properties with a limited number (even one) of available PCRs. As a result of the use of this embodiment the prover device may attest only those properties that the verifier is interested in, thereby enhancing the privacy of the prover and making the task of the verifier easier.

In a second aspect the exemplary embodiments, and in accordance with the PCR re-use technique that is a feature of the first aspect, there is provided a technique to attest a few useful properties, such as application identities and privileges, without the need to setup and maintain a new certification infrastructure. This technique can “bootstrap” from existing and already operational certification infrastructures, such as Symbian Signed or Java application signing, that define mappings from exact software configurations to properties including application identities and privileges. The use of this embodiment facilitates the real-world deployment of property-based attestation. Symbian Signed is an industry wide and commonly used testing and certification program for Symbian C++ applications.

Before describing in further detail the exemplary embodiments, reference can be made to FIG. 3 for showing an example of a mobile platform (NIP) 10 that is in wireless communication via link 11 with an access point (AP) 12 of a wireless network 1. The network 1 may include a network control element (NCE) 14 that may include mobile management entity (MME)/gateway (GW) functionality and which can provide connectivity with a further network, such as a telephone network and/or a data communications network (e.g., the internet). The MP 10 includes a controller, such as a computer or a data processor (DP) 10A, a computer-readable memory medium embodied as a memory (MEM) 10B that stores a program of computer instructions (PROG) 10C, and a suitable radio frequency (RF) transceiver 10D for bidirectional wireless communications with the AP 12 via one or more antennas. The AP 12 also includes a controller, such as a computer or a data processor (DP) 12A, a computer-readable memory medium embodied as a memory (MEM) 12B that stores a program of computer instructions (FROG) 12C, and a suitable RF transceiver 12D for communication with the MP 10 via one or more antennas. The AP 12 is coupled via a data/control path 13 to the NCE 14.

For the purposes of describing the exemplary embodiments of this invention the MP 10 may be assumed to also include a TPM/MTM 10E that can be implemented in HW, SW or as a combination of HW and SW (and firmware). The program 10C can implement an OS, as well as all or some of the functionality of the TPM/MTM 10E. The memory can also store trusted software (TS) 10F. Also included are a set of PCRs 10G that can be realized as memory locations in the memory 10B, or as HW registers, or as a combination of memory locations and HW registers. The TMP/MTM 10E is assumed to operate in accordance with the exemplary embodiments of this invention as described below, where the MP 10 may be referred to generally as a prover device 10.

In general, the various embodiments of the MP 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions. The computer readable MEMS 10B and 12B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on multi-core processor architectures, as non-limiting examples. All or some of the functionality of the MP 10 and the AP 12 shown in FIG. 3 can be implemented in one or more respective ASICs.

Describing now the first aspect of the exemplary embodiments in greater detail, reference can be made to FIG. 1 for describing the attestation with PCR re-use technique. General reference with respect to attestation can be made to section 4.1.2 (pages 5 and 6) of the document TSG Specification Architecture Overview”, Specification Revision 1.4, 2 Aug. 2007.

A prover device 10 (e.g., which may be implemented as the MP 10 of FIG. 3) is equipped with a TPM or MTM (shown together as the TPM/MTM 10E). The TPM/MTM 10E includes a signing key referred to as an Attestation Identity Key (AIK) that has been certified by a trusted authority. The public key of the trusted authority (PK_{CA}) is available to a verifier 20. On the prover device 10 operating system side there is the trusted software component (TS 10F in FIG. 3).

The verifier 20 may be coupled to the prover device 10 via the AP 12 and one or more intervening communication links (wired links and/or wireless links).

The attestation process begins at the time the verifier 20 sends a random challenge C to the prover device 10 (step 1). The trusted software 10F on the prover device 10 first reads and saves the current value (“old” value X) of the PCR 10G that is selected to be used for attestation (step 2). Then the trusted software 10F obtains the requested measurement (or property) M (step 3) and extends the used PCR 10G with the obtained measurement M. The new value X′ in the selected PCR 10G is a cryptographic hash (h) calculated over the old PCR value and the measurement (step 5). That is, X′=h(X∥M). The trusted software 10F then triggers the attestation with challenge C (step 6) sent to the TPM/MTM 10E. The attestation A is a signature over the new PCR value and the challenge (step 7). That is, the attestation A=Sig(AIK, X′∥C). The attestation A, measurement value M and old PCR value X are sent to the verifier 20 (steps 8 and 9). At step 10 the verifier 20 checks that extending the old PCR value X with the measurement M results in new value X′ that has been attested. The verifier 20 also checks (for freshness) that the challenge inside the attestation matches the one it selected earlier, and that the AIK has been certified by a trusted authority. The verifier 20 verifies the received Cert with PK_{CA} and then verifies A with M, X and Cert.

As was indicated above, the “old” PCR value X is sent to the verifier 20. An important difference as compared to traditional attestation is that all old measurement/properties are not sent to the verifier 20. Thus, if one assumes that there are a large number of possible measurements/properties in the system (as typically is the case), the verifier 20 cannot determine the measurements/properties from X since X is calculated using the PCR extended mechanism which in turn uses a one-way hash function.

Thus, if all old measurements/properties are sent to the verifier 20 they can be hashed together (using the PCR extend mechanism) and the result can be verified against X. But knowing only X does not reveal all old measurements/properties (unless possibly there are only a very few properties in the system, which could make it feasible to attempt all possible property combinations to determine if any of them would result in X).

One significant difference between the approach in accordance with the exemplary embodiments of this invention and a conventional approach (traditional TCG-style attestation) is that in this embodiment the old PCR value X is sent to the verifier 20 instead of all previous measurements (or properties) that have been extended and in that way accumulated into the used PCR 10G. As a result, the prover device 10 is enabled to attest only the measurement (or property) that the verifier 20 is actually interested in, and the same PCR 10G can be re-used later for attesting other measurements (or properties). Thus, an arbitrary number of properties can be attested independently of each other, even in the case where there is but a single available PCR.

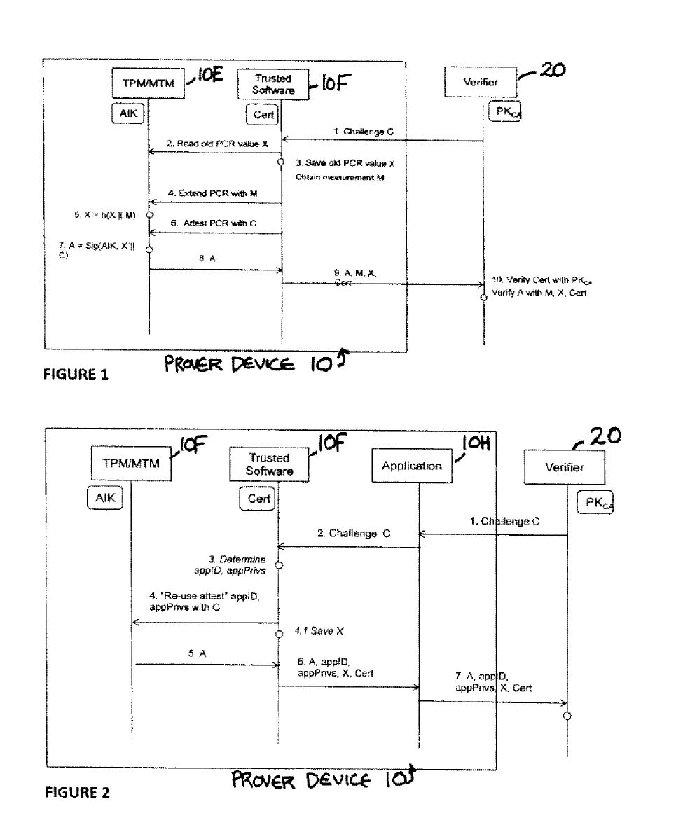

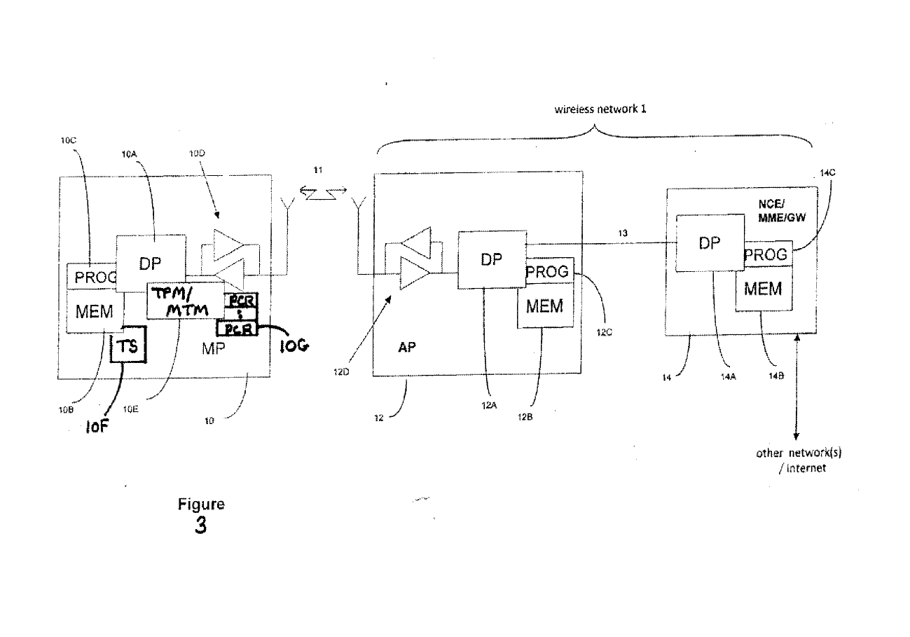

Describing now the second aspect of the exemplary embodiments in greater detail, reference can be made to FIG. 2 for describing attestation using existing infrastructures.

More specifically, FIG. 2 describes a protocol for attesting properties of an application 10H, such as identities and privileges, utilizing existing certification infrastructures, such as Symbian Signed or Java application signing.

The verifier 20 selects a random challenge C and sends the challenge C to the application 10H whose properties are to be verified (step 1). The application forwards the challenge to the trusted software 10F on the prover device 10 (step 2), which determines the properties of the application 10H (step 3). Which properties, and how they are determined by the trusted software 10F can depend on the underlying operating system. For example, in the Symbian OS the identity and privileges of an application can be provided to system server components by the underlying platform security framework.

At steps 4, 5 and 6 the trusted software 10F and the TPM/MTM 10F perform the PCR re-use attestation as was described above with reference to FIG. 1. This can be accomplished for each attested property separately, or for all attested properties at the same time. This operation includes first saving the current PCR value, then extending it with the desired property(s), and finally creating a signed attestation. At step 7 the signed attestation can be sent to the verifier 20 together with the attested property(s), and the old PCR value and device certificate.

This property-based attestation can be used on any platform in which trusted system components can reliably determine certified properties about applications that they are communicating with.

At least one technical advantage and technical effect that is realized is that the PCR re-use attestation does not reveal unnecessary information about the prover device 10 and thus provides enhanced privacy. Further, the ability to provide the attestation by using existing infrastructure bootstrapping implies that the attestation can be readily deployed, as no new infrastructure needs to be specified, configured and operated.

Based on the foregoing it should be apparent that the exemplary embodiments of this invention provide a method, apparatus and computer program(s) to enhance the operation of a data processing system that is involved with a mobile trusted module. The exemplary embodiments provide for improved property-based attestation with enhanced user privacy.

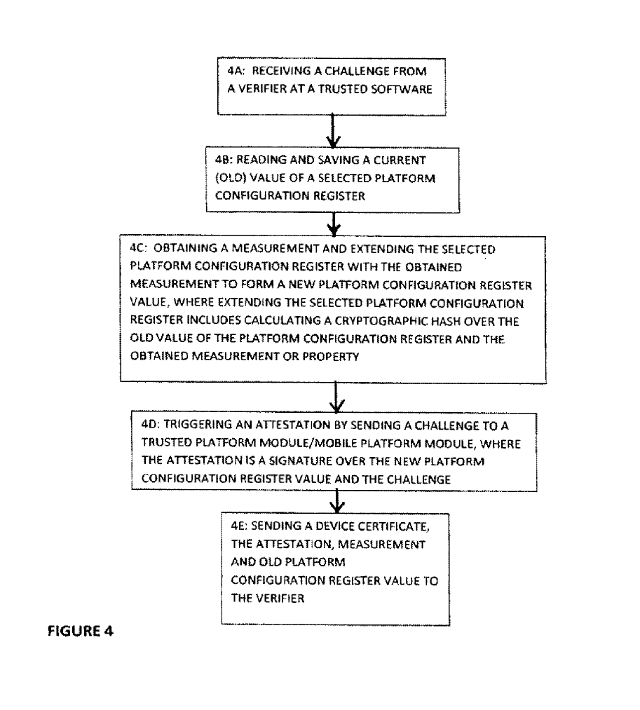

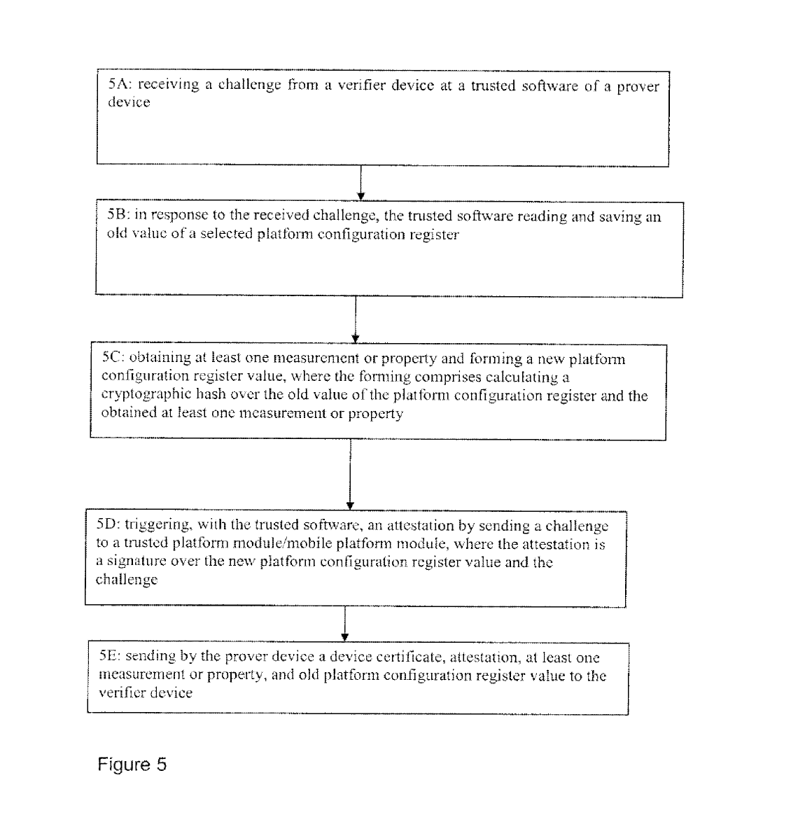

FIG. 4 is a logic flow diagram that illustrates the operation of a method, and a result of execution of computer program instructions, in accordance with the exemplary embodiments of this invention. In accordance with these exemplary embodiments a method performs in a prover device, at Block 4A, a step of receiving a challenge from a verifier at a trusted software. At Block 4B the trusted software reads and saves a current (old) value of a selected platform configuration register. At Block 4C the trusted software obtains a measurement or property and extends the selected platform configuration register with the obtained measurement or property to form a new platform configuration register value, where extending the selected platform configuration register includes calculating a cryptographic hash over the old value of the platform configuration register and the obtained measurement or property. At Block 4D the trusted software triggers an attestation by sending a challenge to a trusted platform module/mobile platform module, where the attestation is a signature over the new platform configuration register value and the challenge. At Block 4E there is a step of sending the device certificate, attestation, measurement and old platform configuration register value to the verifier.

In the method as in the preceding paragraph, further comprising the verifier checking that extending the old platform configuration register value with the measurement results in obtaining the new platform configuration register value that has been attested.

In the method of the preceding paragraph, further comprising the verifier also checking that the challenge contained in the attestation matches the challenge sent earlier by the verifier in step 4A, and that an attestation identity key has been certified by a trusted authority.

In the method of the preceding paragraphs, where the challenge from the verifier is received by an application, which forwards the challenge to the trusted software, and where the attestation sent to the verifier includes one or more properties of the application that are determined by the trusted software and used to extend the selected platform configuration register.

In the method of the preceding paragraph, where the one or more properties comprise at least one of an application identifier and application privileges.

The exemplary embodiments of this invention also provide an apparatus that comprises a processor and a memory including computer program code, where the memory and computer program code are configured to, with the processor, cause the apparatus at least to perform receiving a challenge from a verifier at a trusted software; the trusted software reading and saving a current (old) value of a selected platform configuration register; the trusted software obtains a measurement or property and extending the selected platform configuration register with the obtained measurement or property to form a new platform configuration register value, where extending the selected platform configuration register includes calculating a cryptographic hash over the old value of the platform configuration register and the obtained measurement or property; triggering an attestation by sending a challenge to a trusted platform module/mobile platform module, where the attestation is a signature over the new platform configuration register value and the challenge; and sending the attestation, measurement and old platform configuration register value are to the verifier.

The exemplary embodiments of this invention also provide an apparatus that comprises means for receiving a challenge from a verifier at a trusted software, means, in response to the received challenge, for reading and saving a current (e.g., old) value of a selected platform configuration register, means for obtaining a measurement or property and extending the selected platform configuration register with the obtained measurement or property to form a new platform configuration register value, where extending the selected platform configuration register includes calculating a cryptographic hash over the old value of the platform configuration register and the obtained measurement or property, means for triggering, with the trusted software, an attestation by sending a challenge to a trusted platform module/mobile platform module, where the attestation is a signature over the new platform configuration register value and the challenge, and means for sending the device certificate, attestation, measurement and old platform configuration register value to the verifier.

Further, in the apparatus of the preceding paragraph the means for the sending comprises a transmitter, the means for the receiving comprises a receiver, and the means for the reading, the saving, the obtaining, the extending, and the triggering comprises at least one memory including at least one program of computer instructions executed by at least one data processor.

FIG. 5 is a logic flow diagram that illustrates the operation of a method, and a result of execution of computer program instructions, in accordance with the exemplary embodiments of this invention. In accordance with these exemplary embodiments a method performs, at Block 5A, receiving a challenge from a verifier device at a trusted software of a prover device. At Block 5B there is, in response to the received challenge, the trusted software reading and saving an old value of a selected platform configuration register. At Block 5C there is obtaining at least one measurement or property and forming a new platform configuration register value, where the forming comprises calculating a cryptographic hash over the old value of the platform configuration register and the obtained at least one measurement or property. At Block 5D there is triggering, with the trusted software, an attestation by sending a challenge to a trusted platform module/mobile platform module, where the attestation is a signature over the new platform configuration register value and the challenge. At Block 5E there is sending by a prover device a device certificate, attestation, at least one measurement or property, and old platform configuration register value to the verifier device.

In the method of the previous paragraph, the challenge from the verifier device is received by an application, which forwards the challenge to the trusted software, and where the attestation sent to the verifier device includes one or more properties of the application that are determined by the trusted software and used to extend the selected platform configuration register.

In the method of the previous paragraph, the one or more properties comprise at least one of an application identifier and application privileges.

In the method of the previous paragraphs, the sent attestation signature equals Sig(AIK, X′∥C), where AIK is an attestation identity key, where X′ is the new platform configuration register value, and where C is a challenge.

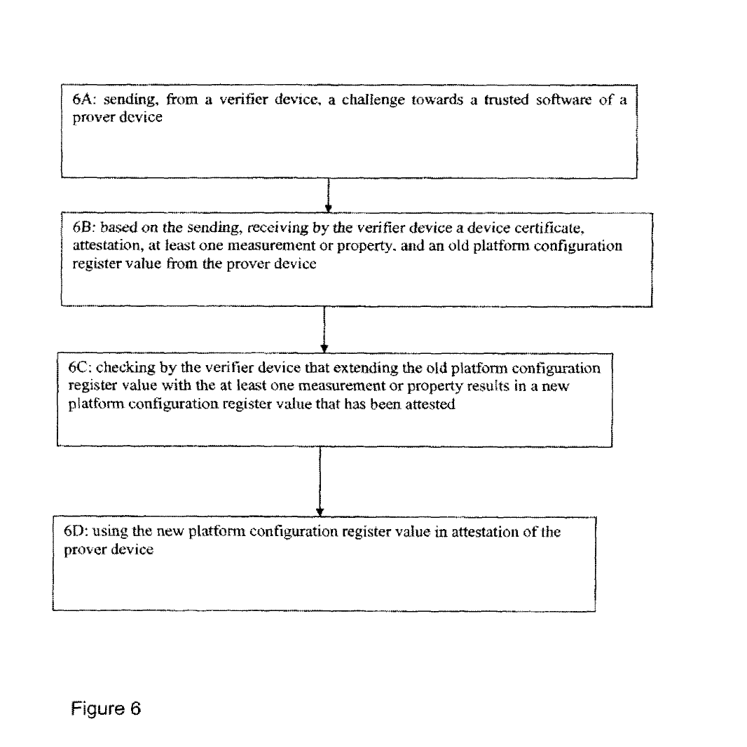

FIG. 6 is a logic flow diagram that illustrates the operation of a method, and a result of execution of computer program instructions, in accordance with the exemplary embodiments of this invention. In accordance with these exemplary embodiments a method performs, at Block 6A, sending, from a verifier device, a challenge toward a trusted software of a prover device. At Block 6B there is, based on the sending, receiving by the verifier device a device certificate, attestation, at least one measurement or property, and an old platform configuration register value from the prover device. At Block 6C there is checking by the verifier device that extending the old platform configuration register value with the at least one measurement or property results in a new platform configuration register value that has been attested. At Block 6D there is using the new platform configuration register value in attestation of the prover device.

In the method of the preceding paragraph, the checking comprises extending the old platform configuration register value with the measurement.

In the method of the preceding paragraphs, further comprising the verifier device also checking that a challenge contained in the attestation matches the challenge sent earlier by the verifier device, and that an attestation identity key has been certified by a trusted authority.

Further, in the method of the preceding paragraph, wherein a challenge is sent by the verifier device toward an application of the prover device, wherein the attestation received from the prover device includes at least one property of the application which have been determined by the trusted software and used to extend the selected platform configuration register.

The exemplary embodiments of this invention also provide an apparatus that comprises at least one data processor, and at least one memory including at least one program of computer instructions, where the at least one memory and the at least one program of computer instructions are configured, with the at least one data processor, to cause the apparatus to at least: send, from a verifier device to a prover device, a challenge toward a trusted software of prover device, and based on the sending, receive by the verifier device a device certificate, attestation, at least one measurement or property, and an old platform configuration register value from the prover device, check by the verifier device that extending the selected platform configuration register value with the at least one measurement or property results in a new platform configuration register value that has been attested, and use the new platform configuration register value in attestation of the prover device.

Further, the exemplary embodiments of this invention also provide an apparatus that comprises means for sending, from a verifier device, a challenge toward a trusted software of a prover device, and means, based on the sending, for receiving by the verifier device a device certificate, attestation, at least one measurement or property, and an old platform configuration register value from the prover device, means for checking by the verifier device that extending the old platform configuration register value with the measurement results in a new platform configuration register value that has been attested, and means for using the new platform configuration register value in attestation of the prover device.

Further, in the apparatus of the preceding paragraph the means for the sending comprises a transmitter, the means for the receiving comprises a receiver, and the means for the checking and the using comprises at least one memory including at least one program of computer instructions executed by at least one data processor.

The various blocks shown in FIG. 4, FIG. 5, and FIG. 6 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters are not intended to be limiting in any respect, as these parameters may be identified by any suitable names. Further, the formulas and expressions that use these various parameters may differ from those expressly disclosed herein. Further, the various names assigned to different events (e.g., challenge, etc.) are not intended to be limiting in any respect, as these various events may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1-21. (canceled)

22. A method, comprising:
receiving a challenge from a verifier device at a trusted software of a prover device;
in response to the received challenge, the trusted software reading and saving an old value of a selected platform configuration register;
obtaining at least one measurement or property and forming a new platform configuration register value, where the forming comprises calculating a cryptographic hash over the old value of the platform configuration register and the obtained at least one measurement or property;
triggering, with the trusted software, an attestation by sending a challenge to a trusted platform module/mobile platform module, where the attestation is a signature over the new platform configuration register value and the challenge; and
sending by the prover device a device certificate, attestation, at least one measurement or property, and old platform configuration register value to the verifier device.

23. The method according to claim 22, where the challenge from the verifier device is received by an application, which forwards the challenge to the trusted software, and where the attestation sent to the verifier device includes one or more properties of the application that are determined by the trusted software and used to extend the selected platform configuration register.

24. The method according to claim 23, where the one or more properties comprise at least one of an application identifier and application privileges.

25. The method according to claim 22, where the sent attestation signature equals Sig(AIK, X′∥C), where AIK is an attestation identity key, where X′ is the new platform configuration register value, and where C is a challenge.

26. The method as in any of the preceding claims performed by a non-transitory memory embodying at least one program of computer instructions executed by at least one data processor.

27. An apparatus, comprising:
at least one data processor; and
at least one memory including at least one program of computer instructions, where the at least one memory and the at least one program of computer instructions are configured, with the at least one data processor, to cause the apparatus to at least:
receive a challenge from a verifier device at a trusted software;
in response to the received challenge, read and save an old value of a selected platform configuration register;
obtain at least one measurement or property and forming a new platform configuration register value, where the forming comprises calculating a cryptographic hash over the old value of the platform configuration register and the obtained at least one measurement or property;
trigger, with the trusted software, an attestation by sending a challenge to a trusted platform module/mobile platform module, where the attestation is a signature over the new platform configuration register value and the challenge; and
send a device certificate, attestation, at least one measurement or property, and old platform configuration register value to the verifier device.

28. The apparatus according to claim 27, where the challenge from the verifier device is received by an application, which forwards the challenge to the trusted software, and where the attestation sent to the verifier device includes one or more properties of the application that are determined by the trusted software and used to extend the selected platform configuration register.

29. The apparatus according to claim 28, where the one or more properties comprise at least one of an application identifier and application privileges.

30. The apparatus according to claim 27, where the sent attestation signature equals Sig(AIK, X′∥C), where AIK is an attestation identity key, where X′ is the new platform configuration register value, and where C is a challenge.

31. An apparatus, comprising:
at least one data processor; and
at least one memory including at least one program of computer instructions, where the at least one memory and the at least one program of computer instructions are configured, with the at least one data processor, to cause the apparatus to at least:
send, from a verifier device, a challenge toward a trusted software of a prover device; and
based on the sending, receive by the verifier device a device certificate, attestation, at least one measurement or property, and an old platform configuration register value from the prover device;
check by the verifier device that extending the selected platform configuration register value with the at least one measurement or property results in a new platform configuration register value that has been attested; and
use the new platform configuration register value in attestation of the prover device.

32. The apparatus according to claim 31, further comprising the verifier device also checking that a challenge contained in the attestation matches the challenge sent earlier by the verifier device, and that an attestation identity key has been certified by a trusted authority.

33. The apparatus according to claim 32, wherein the challenge is sent to an application of the prover device, wherein the attestation received from the prover device includes at least one property of the application which have been determined by the trusted software and used to extend the old platform configuration register.
